(19) United States
(12) Patent Application Publication
(10) Pub. No.: US 2007/0013436 A1
(43) Pub. Date: Jan. 18, 2007

(54) Bandgap reference circuit

(76) Inventor: Yi-Chung Chou, Taipei City (TW)

Correspondence Address: J C PATENTS, INC., 4 VENTURE, SUITE 250, IRVINE, CA, 92618, US

(21) Appl. No.: 11/192,892

(22) Filed: Jul. 28, 2005

(30) Foreign Application Priority Data
Jun. 17, 2005 (TW) 94120137

(51) Int. Cl. G05F 1/10

(52) U.S. Cl. 327/539

(57) ABSTRACT

The present invention provides a bandgap reference circuit, which includes a first current source, a second current source, a first reference circuit, a second reference circuit, and a selection circuit. The first reference circuit is coupled to the first current source and the second current source for outputting a first voltage signal. The second reference circuit is coupled to the first current source and the second current source for outputting a second voltage signal, wherein there is a phase difference between the first voltage signal and the second voltage signal. The selection circuit is coupled to the first reference circuit and the second reference circuit. One of the first voltage signal and the second voltage signal is alternatively selected by the selection circuit as an output reference voltage.

### CROSS-REFERENCE TO RELATED APPLICATION

This application claims the priority benefit of Taiwan application serial no. 94120137, filed on Jun. 17, 2005. All disclosure of the Taiwan application is incorporated herein by reference.

### BACKGROUND OF THE INVENTION

1. Field of Invention

The present invention relates to an analog circuit, and particularly to a bandgap reference circuit.

2. Description of the Related Art

Voltage reference circuits and current reference circuits are widely used in analog circuits. The reference circuits provide a DC level which is only loosely related to the fabricating process parameters. For example, a bias current of a differential pair circuit must rely on a reference circuit to be generated. In the differential pair circuit, the generated bias current in reverse affects the voltage gain and noise of the circuit. Similarly, in an analog-to-digital converter (ADC) and a digital-to-analog converter (DAC), the entire input/output range must be defined by a reference circuit.

FIG. 1A is a schematic drawing of a conventional on-off bandgap reference circuit provided by U.S. Pat. No. 5,563,504. Referring to FIG. 1A, the conventional on-off bandgap reference circuit includes current sources I101 and I102, switches S101 and S102, capacitors C101 and C102, a bipolar transistor Q100 and an operational amplifier A100. The operation signals are shown in FIG. 1B. Referring to FIGS. 1A and 1B, when the switch S101 is on and the other switch S102 is off, the bandgap reference circuit works in a pre-charge mode. While the switch S102 is on and the other switch S101 is off, the bandgap reference circuit works in a reference voltage mode, during which the circuit provides a required reference voltage Vo.

U.S. Pat. No. 5,867,012 provides another conventional on-off bandgap reference circuit as shown in FIG. 2A. The circuit includes current sources I201 and I202, switches S201, S202, S203, S204 and S205, capacitors C201 and C202, bipolar transistors Q201 and Q202, and an operational amplifier A200. The operation signals thereof are shown in FIG. 2B. Referring to FIG. 2B, similar to FIG. 1B, when the switches S201, S203 and S205 are on and the switches S202 and S204 are off, the bandgap reference circuit works in a pre-charge mode. While the switches S202 and S204 are on and the switches S201, S203 and S205 are off, the bandgap reference circuit works in a reference voltage mode, during which the circuit provides a required reference voltage Vo.

Although a reference voltage can be produced in a bandgap reference circuit of the prior art by turning on and off of the switches, it can be seen in FIG. 1B or 2B that only during reference voltage mode, the conventional bandgap reference circuit outputs a required, stable reference voltage level, and during other mode it produces undesired voltages.

Therefore, there is an increasing need to develop a bandgap reference circuit capable of outputting a stable reference voltage level constantly.

### SUMMARY OF THE INVENTION

An object of the present invention is to provide a bandgap reference circuit suitable for producing a stable reference voltage level.

A bandgap reference circuit provided by an embodiment of the present invention includes a first current source, a second current source, a first reference circuit, a second reference circuit and a selection circuit. The first reference circuit is coupled to the first current source and the second current source for outputting a first voltage signal. The second reference circuit is coupled to the first current source and the second current source for outputting a second voltage signal. Wherein, there is a phase difference between the first voltage signal and the second voltage signal. The selection circuit is coupled to the first reference circuit and the second reference circuit for selecting one voltage signal as an output voltage from the first voltage signal and the second voltage signal.

Since a plurality of switches are employed to switch the reference circuits in the embodiment, thus a stable output reference voltage level can be obtained.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a schematic drawing of a conventional on-off bandgap reference circuit.

FIG. 1B is an operation signal chart of the conventional on-off bandgap reference circuit in FIG. 1A.

FIG. 2A is a schematic drawing of another conventional on-off bandgap reference circuit.

FIG. 2B is an operation signal chart of the conventional on-off bandgap reference circuit in FIG. 2A.

FIG. 3 is a block diagram showing a bandgap reference circuit according to an embodiment of the present invention.

FIG. 4 is a schematic drawing of a bandgap reference circuit according to another embodiment of the present invention.

FIG. 5 is an operation signal chart of the bandgap reference circuit in FIG. 4.

FIG. 6 is a schematic drawing of a bandgap reference circuit according to still another embodiment of the present invention.

FIG. 7 is an operation signal chart of the bandgap reference circuit in FIG. 6.

FIG. 8 is a schematic drawing of a bandgap reference circuit according to yet another embodiment of the present invention.

FIG. 9 is an operation signal chart of the bandgap reference circuit in FIG. 8.

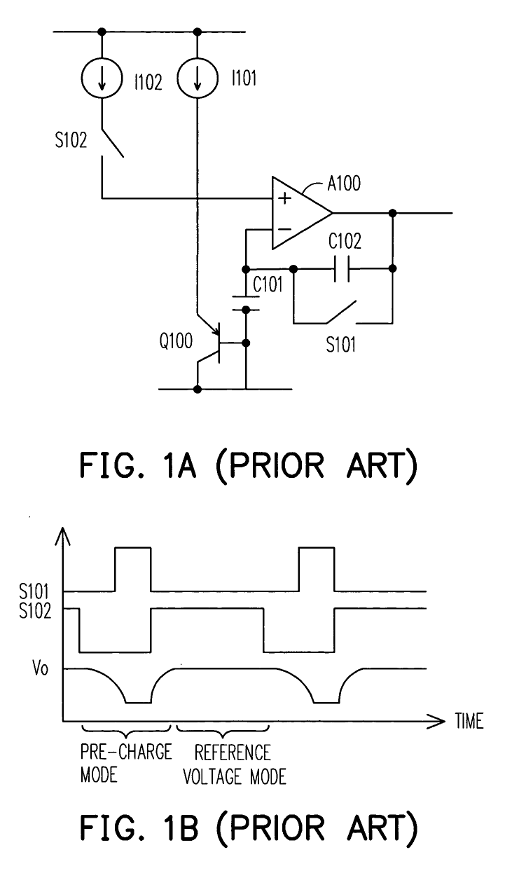

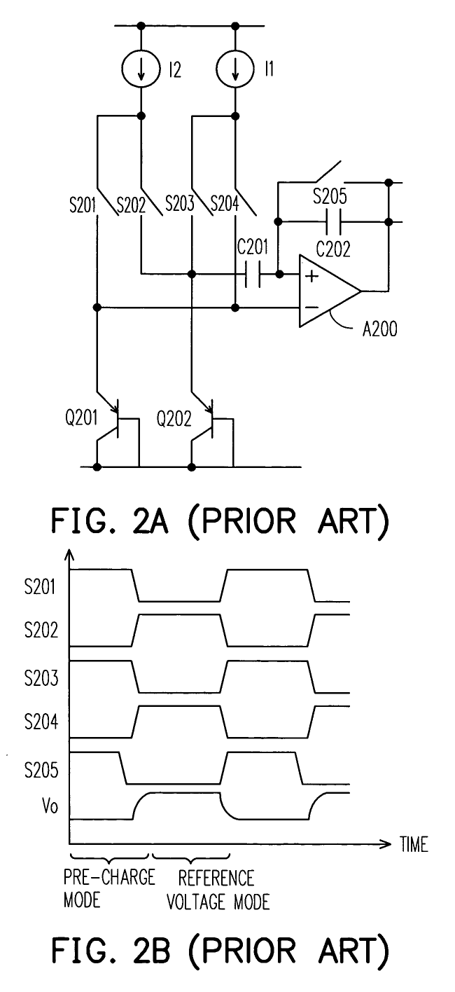

### DESCRIPTION OF THE EMBODIMENTS

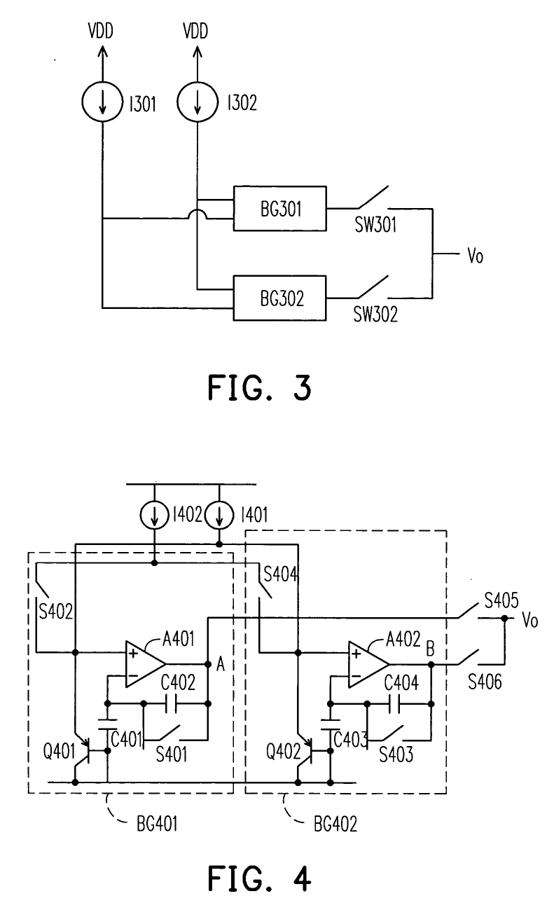

FIG. 3 is a block diagram showing a bandgap reference circuit according to an embodiment of the present invention. Referring to FIG. 3, the circuit mainly includes current sources I301 and I302, reference circuits BG301 and BG302, and switches SW301 and SW302. FIG. 4 is a schematic drawing showing the bandgap reference circuit according to another embodiment of the present invention. Referring to FIG. 4, the circuit includes two current sources I401 and I402, two amplifiers A401 and A402, two bipolar transistors Q401 and Q402, four capacitors C401, C402, C403 and C404, and six switches S401-S406. Wherein, the capacitance ratio of C401 over C402 is the same as the ratio of C403 over C404. Two nodes, A and B, are indicated in FIG. 4 for a clear explanation.

The current source I401 is coupled to the emitter ends of the bipolar transistors Q401 and Q402, and the positive input ends of the operational amplifiers A401 and A402, respectively. The current source I402 is coupled to the positive input ends of the operational amplifiers A410 and A402 via the switches S401 and S404, respectively. Both the bases and the collectors of the bipolar transistors Q401 and Q402 are grounded. The capacitor C401 is coupled between the base of the bipolar transistor Q401 and the negative input end of the operational amplifier A401. The capacitor C403 is coupled between the base of the bipolar transistor Q402 and the negative input end of the operational amplifier A402. The capacitor C402 is coupled between the negative input end of the operational amplifier A401 and the output end thereof. Both ends of the capacitor C402 are connected in parallel with the switch S401. The capacitor C404 is coupled between the negative input end of the operational amplifier A402 and the output end thereof. Both ends of the capacitor C404 are connected in parallel with the switch S403. The switch S405 is connected between the node A and the output terminal Vo. The switch S406 is connected between the node B and the output terminal Vo.

In FIG. 4, the switches S405 and S406, the current sources I401 and I402 and the dotted frames BG401 and BG402 correspond to SW301 and SW302, I301 and I302 and the reference circuits BG301 and BG302 in FIG. 3, respectively.

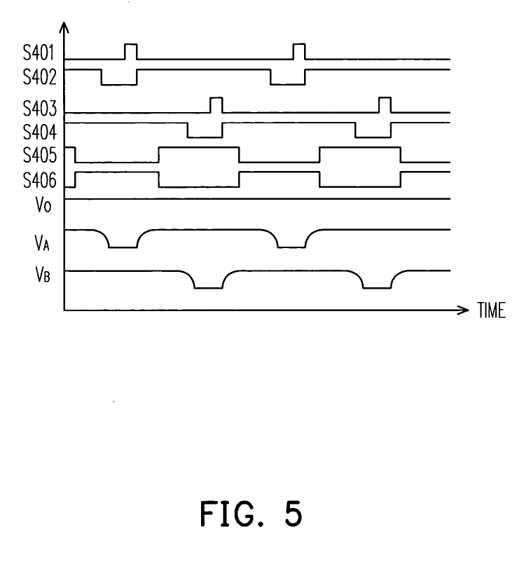

FIG. 5 is an operation signal chart of the circuit in FIG. 4. Referring to FIG. 4 and FIG. 5, high-level operation signals of the switches S401-S406 indicate a switching-on status and low-level operation signals indicate a switching-off status. It can be seen from the chart that the signal of the switch S401 (S402) has a 180 degree phase difference from the signal of the switch S403 (S404), and there is also a 180 degree phase difference between the signal V_{A} of the node A and the signal V_{B} of the node B. Therefore, once V_{A} becomes a reference voltage, the switch S405 is turned on and the switch S406 is turned off, so as to obtain a stable reference voltage at Vo. On the other hand, once V_{B} becomes a reference voltage, the switch S405 is turned off and the switch S406 is turned on, to obtain a stable reference voltage at Vo. In this way, by alternating the on status of the switch S405 and S406 corresponding to the node A and the node B under the reference voltage mode respectively, a stable reference voltage level at the output terminal can be obtained.

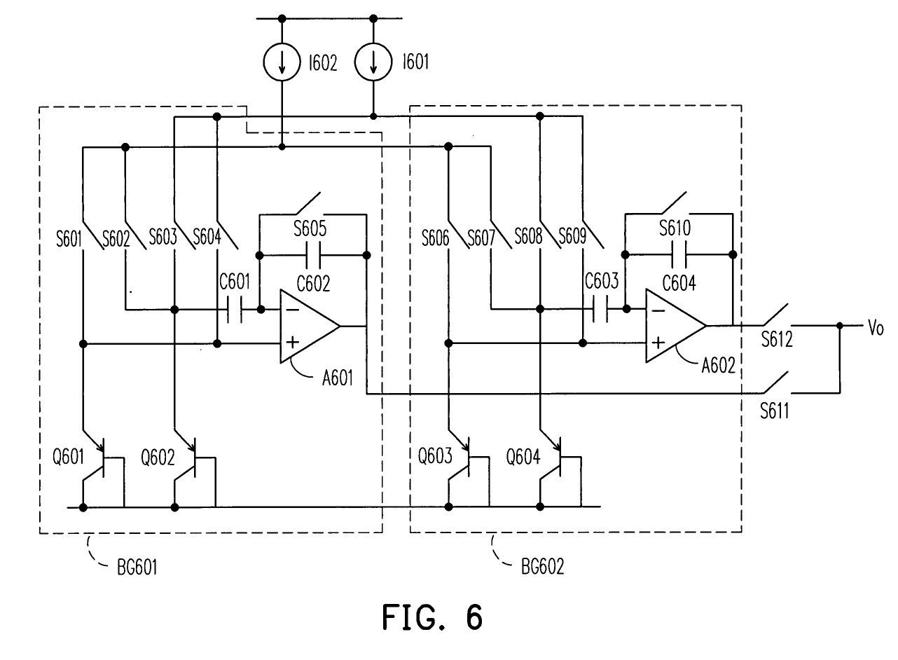

FIG. 6 is a schematic drawing of a bandgap reference circuit according to FIG. 3. The circuit includes current sources I601 and I602, switches S601-S612, bipolar transistors Q601-Q604, capacitors C601-C604 and operational amplifiers A601 and A602. Wherein, the capacitance ratio of C601 over C602 is the same as the ratio of C603 over C604.

The current source I601 is coupled to the emitter end of the bipolar transistor Q602 via the switch S603 and one end of the capacitor C601. The current source I601 is also coupled to the emitter end of the bipolar transistors Q601 via the switch S604 and the positive input end of the operational amplifier A601. The current source I601 is further coupled to the emitter end of the bipolar transistors Q604 via the switch S608 and one end of the capacitor C603. The current source I601 is further coupled to the emitter end of the bipolar transistors Q603 via the switch S609 and the positive input end of the operational amplifiers A602. The current source I602 is coupled to the emitter end of the bipolar transistor Q601 via the switch S601 and the positive input end of the operational amplifier A601. The current source I602 is also coupled to the emitter end of the bipolar transistor Q602 via the switch S602 and one end of the capacitor C601. The current source I602 is further coupled to the emitter end of the bipolar transistors Q603 via the switch S606 and the positive input end of the operational amplifier A602. The current source I602 is further coupled to the emitter end of the bipolar transistor Q604 via the switch S607 and one end of the capacitor C603.

Both the bases and collectors of the bipolar transistors Q601-Q604 are grounded. Another end of the capacitor C601 is coupled to the negative end of the operational amplifier A601. Another end of the capacitor C603 is coupled to the negative input end of the operational amplifier A602. The capacitor C602 is coupled between the negative input end of the operational amplifier A601 and the output end thereof. The switch S605 is coupled between both ends of the capacitor C602. The capacitor C604 is coupled between the negative input end of the operational amplifier A602 and the output end thereof. The switch S610 is coupled between both ends of the capacitor C604. The output end of the operational amplifier A601 is connected to the output terminal Vo via the switch S611. The output end of the operational amplifier A602 is connected to the output terminal Vo via the switch S612.

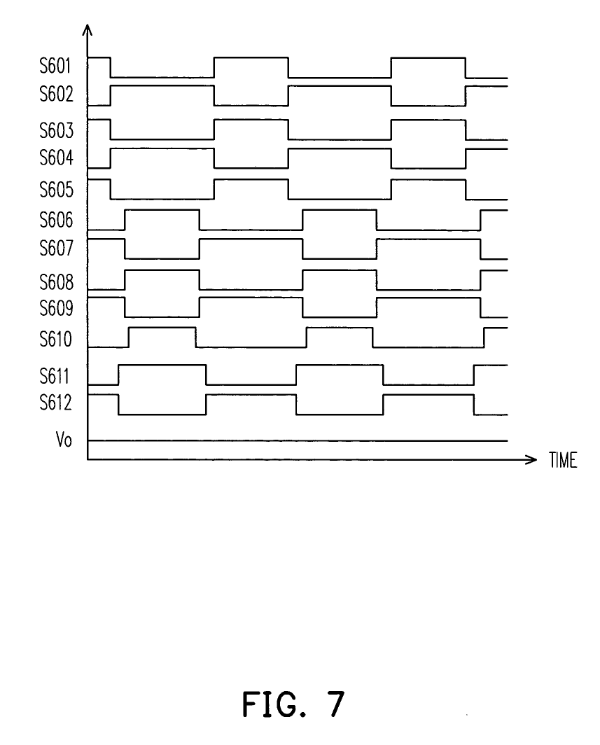

FIG. 7 is an operation signal chart of the bandgap reference circuit in FIG. 6. In FIG. 6, the switches S611 and S612, the current sources I601 and I602 and the dotted frames BG601 and BG602 correspond to SW301 and SW302, I301 and I302, and the reference circuits BG301 and BG302 in FIG. 3, respectively. A stable reference voltage level is obtained herein by also alternating the on status of the switch S611 and S612. In addition, the BG601 in FIG. 6 can be replaced by the BH401 in FIG. 4, or the BG602 in FIG. 6 can be replaced by the BH402 in FIG. 4 to get a stable reference level without departing from the scope or spirit of the invention.

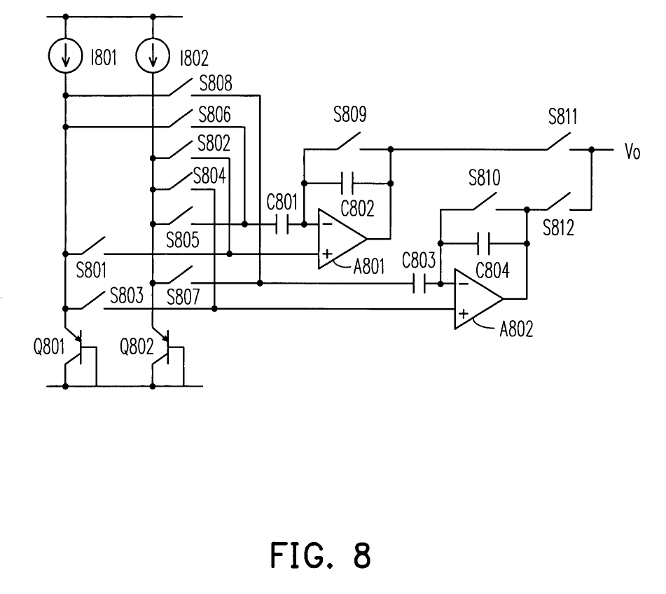

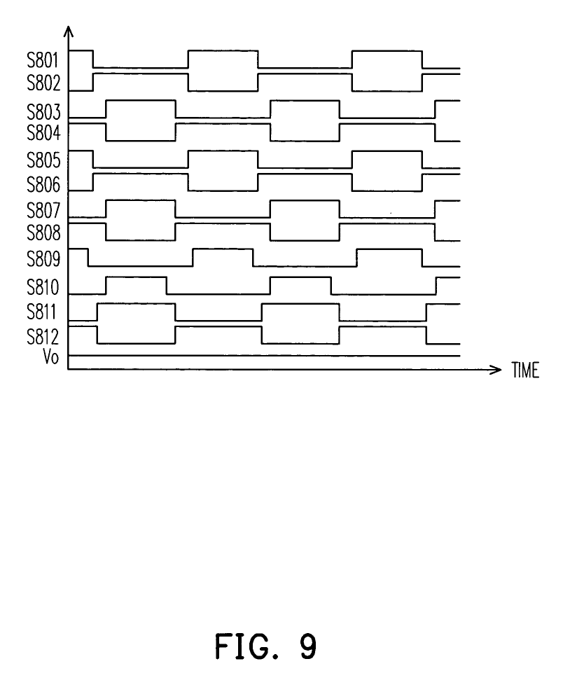

FIG. 8 is a schematic drawing of a bandgap reference circuit according to yet another embodiment of the present invention. The layout of FIG. 8 is similar to the one in FIG. 6, except the switch locations are different from the ones in FIG. 6. Thus, two bipolar transistors in FIG. 8 are saved in comparison with FIG. 6. FIG. 9 is an operation signal chart of the bandgap reference circuit in FIG. 8, which is similar to FIG. 6, so the description is omitted.

In summary, from above described, in the embodiments of the present invention, a scheme of alternating the on status of the switch is used for producing an output reference voltage level. Consequently, the goal of obtaining a stable output reference voltage level is achieved.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A bandgap reference circuit, comprising:
a first current source;
a second current source;
a first reference circuit, coupled to the first current source and the second current source for outputting a first output voltage signal;
a second reference circuit, coupled to the first current source and the second current source for outputting a second output voltage signal, wherein there is a phase difference between the first voltage signal and the second voltage signal;
a selection circuit, coupled to the first reference circuit and the second reference circuit for selecting one of the first voltage signal and the second voltage signal as an output voltage.

2. The bandgap reference circuit as recited in claim 1, wherein the selection circuit comprises:
a first switch, coupled between the first reference circuit and an output terminal, wherein if the first voltage signal is a reference voltage level, the first switch is turned on; and
a second switch, coupled between the second reference circuit and the output terminal, wherein if the second voltage signal is a reference voltage level, the second switch is turned on, wherein, when one of the first switch and the second switch is on, another switch if off.

3. The bandgap reference circuit as recited in claim 2, wherein the first reference circuit comprises:
an amplifier, comprising a positive input end, a negative input end and an output end, wherein the positive input end is coupled to the first current source and the output end is coupled to the first switch;
a first capacitor, wherein one end thereof is coupled to the negative input end and another end thereof is coupled to the output end of the amplifier;
a third switch, wherein one end thereof is coupled to the second current source and another end thereof is coupled to the positive input end;
a fourth switch, wherein one end thereof is coupled to the negative input end and another end thereof is coupled to the output end of the amplifier;
a second capacitor, wherein one end thereof is coupled to the negative input end and another end thereof is grounded; and
a bipolar transistor, wherein the collector and the base thereof are grounded, and the emitter thereof is coupled to the positive input end of the amplifier.

4. The bandgap reference circuit as recited in claim 2, wherein the second reference circuit comprises:
an amplifier, comprising a positive input end, a negative input end and an output end, wherein the positive input end is coupled to the first current source and the output end is coupled to the first end of the second switch;
a first capacitor, wherein one end thereof is coupled to the negative input end and another end thereof is coupled to the output end of the amplifier;
a third switch, wherein one end thereof is coupled to the second current source and another end thereof is coupled to the positive input end of the amplifier;
a fourth switch, wherein one end thereof is coupled to the negative input end and another end thereof is coupled to the output end of the amplifier;
a second capacitor, wherein one end thereof is coupled to the negative input end of the amplifier and another end thereof is grounded; and
a bipolar transistor, wherein the collector and the base thereof are grounded, and the emitter thereof is coupled to the positive input end of the amplifier.

5. The bandgap reference circuit as recited in claim 2, wherein the first reference circuit comprises:
an amplifier, comprising a positive input end, a negative input end and an output end, wherein the output end is coupled to the first switch;
a first capacitor, wherein one end thereof is coupled to the negative input end and another end thereof is coupled to the output end of the amplifier;
a third switch, wherein one end thereof is coupled to the negative input end and another end thereof is coupled to the output end of the amplifier;
a second capacitor, wherein one end thereof is coupled to the negative input end;
a first bipolar transistor, wherein the collector and the base thereof are grounded, and the emitter thereof is coupled to the positive input end;
a second bipolar transistor, wherein the collector and the base thereof are grounded, and the emitter thereof is coupled to another end of the second capacitor;
a fourth switch, wherein one end thereof is coupled to the first current source and another end thereof is coupled to the positive input end;
a fifth switch, wherein one end thereof is coupled to the second current source and another end thereof is coupled to the positive input end;
a sixth switch, wherein one end thereof is coupled to the first current source and another end thereof is coupled to another end of the second capacitor; and
a seventh switch, wherein one end thereof is coupled to the second current source and another end thereof is coupled to another end of the second capacitor.

6. The bandgap reference circuit as recited in claim 2, wherein the second reference circuit comprises:
an amplifier, comprising a positive input end, a negative input end and an output end, wherein the output end is coupled to the second switch;
a first capacitor, wherein one end thereof is coupled to the negative input end and another end thereof is coupled to the output end of the amplifier;
a third switch, wherein one end thereof is coupled to the negative input end and another end thereof is coupled to the output end of the amplifier;
a second capacitor, wherein one end thereof is coupled to the negative input end;
a first bipolar transistor, wherein the collector and the base thereof are grounded, and the emitter thereof is coupled to the positive input end;
a second bipolar transistor, wherein the collector and the base thereof are grounded, and the emitter thereof is coupled to another end of the second capacitor;
a fourth switch, wherein one end thereof is coupled to the first current source and another end thereof is coupled to the positive input end;
a fifth switch, wherein one end thereof is coupled to the second current source and another end thereof is coupled to the positive input end;
a sixth switch, wherein one end thereof is coupled to the first current source and another end thereof is coupled to another end of the second capacitor; and
a seventh switch, wherein one end thereof is coupled to the second current source and another end thereof is coupled to another end of the second capacitor.

7. The bandgap reference circuit as recited in claim 2, wherein the first reference circuit comprises:
a first amplifier, comprising a positive input end, a negative input end and an output end, wherein the output end is coupled to the first switch;
a first capacitor, wherein one end thereof is coupled to the negative input end and another end thereof is coupled to the output end of the amplifier;
a third switch, wherein one end thereof is coupled to the negative input end and another end thereof is coupled to the output end of the amplifier;
a second capacitor, wherein one end thereof is coupled to the negative input end;
a fourth switch, wherein one end thereof is coupled to the first current source and another end thereof is coupled to the positive input end;
a fifth switch, wherein one end thereof is coupled to the second current source and another end thereof is coupled to the positive input end;
a sixth switch, wherein one end thereof is coupled to the first current source and another end thereof is coupled to another end of the second capacitor;
a seventh switch, wherein one end thereof is coupled to the second current source and another end thereof is coupled to another end of the second capacitor;
a first bipolar transistor, wherein the collector and the base thereof are grounded, and the emitter thereof is coupled to the second current source; and
a second bipolar transistor, wherein the collector and the base thereof are grounded, and the emitter thereof is coupled to the first current source.

8. The bandgap reference circuit as recited in claim 7, wherein the second reference circuit comprises:
a second amplifier, comprising a positive input end, a negative input end and an output end, wherein the output end is coupled to the second switch;
a third capacitor, wherein one end thereof is coupled to the negative input end and another end thereof is coupled to the output end of the amplifier;
an eighth switch, wherein one end thereof is coupled to the negative input end and another end thereof is coupled to the output end of the amplifier;
a fourth capacitor, wherein one end thereof is coupled to the negative input end of the amplifier;
a ninth switch, wherein one end thereof is coupled to the first current source and another end thereof is coupled to the positive input end of the amplifier;
a tenth switch, wherein one end thereof is coupled to the second current source and another end thereof is coupled to the positive input end of the amplifier;
an eleventh switch, wherein one end thereof is coupled to the first current source and another end thereof is coupled to another end of the fourth capacitor; and
a twelfth switch, wherein one end thereof is coupled to the second current source and another end thereof is coupled to another end of the fourth capacitor.
